(19) United States
(12) Patent Application Publication
(10) Pub. No.: US 2022/0151867 A1
(43) Pub. Date: May 19, 2022

(54) CARDIOPULMONARY RESUSCITATION SYSTEM

(71) Applicant: MO.S.A.I.C. - MOTION SYS AND INFO CTRL - S.R.L., Sora (FR) (IT)

(72) Inventors: Giovanni DONARELLI, Sora (FR) (IT); Daniele IAFRATE, Sora (FR) (IT); Massimiliano D'AGOSTINO, Roma (RM) (IT); Luciano CECCHI, Roma (RM) (IT); Chiara BONIELLO, Pescosolido (FR) (IT)

(73) Assignee: MO.S.A.I.C.-MOTION SYSTEM AND INFORMATION CONTROL-S.R.L.

(21) Appl. No.: 17/399,845

(22) Filed: Aug. 11, 2021

(30) Foreign Application Priority Data
Jun. 17, 2020 (IT) 102020000014437

(51) Int. Cl. A61H 31/00

(52) U.S. Cl. CPC A61H 31/006; A61H 31/008; A61H 2203/0456; A61H 2201/1246; A61H 2201/1619; A61H 2201/0119

(57) ABSTRACT

The present invention relates to a cardiopulmonary resuscitation system (1; 2) comprising a chest compression device (11; 12), a support frame (21) of the chest compression device (11; 12) and coupling means (31) of the chest compression device (11; 12) to a patient (200), wherein the chest compression device (11; 12) is pneumatically operated and solidly coupled to the support plate (21) at a side (121) of it support plate (21), and wherein the coupling means (31) comprise a pairs of anchoring devices (131, 231) arranged on opposite ends (321, 421) of the support plate (21) and suitable for anchoring the support plate (21) to the ground (100), wherein the pairs of anchoring devices (131, 231) consist of belts provided with at least an end operatively coupled respectively to one of the opposite ends (321, 421) of the support plate (21), and wherein each of the anchoring devices (131, 231) defines at least a loop allowing an operator to hold them onto the ground (100) by inserting the terminal segment of the upper or lower limbs of the operator within the loops.

### FIELD OF THE INVENTION

The present invention relates to a cardiopulmonary resuscitation system.

In particular, the present invention relates to a cardiopulmonary resuscitation system of the mechanical type and provided with stabilization of chest compression.

### PRIOR ART

Resuscitation consists of several activities that must be performed correctly and at the right times according to predefined resuscitation protocols, including manual chest compressions, rhythm checks, defibrillation, ventilation, medication and patient management strategies. All of these elements are critical to the success of resuscitation.

To ensure adequate cardiovascular support for patients suffering from cardiac arrest, while awaiting the restoration of cardiac functions, it is necessary to perform effective and constant chest compressions over time, as an effective and uninterrupted cardiopulmonary resuscitation allows to increase the chances of survival of patients.

Cardiopulmonary resuscitation can be performed manually by specialized operators, trained and able to operate with predefined protocols to intervene in an emergency event. However, manual CPR may be ineffective, for example because the rescuer may not be able to remember their training, especially under the stress of the moment. And even the trained rescuer can tire in performing chest compressions for a long time, and in this way the performance of chest compressions may deteriorate. Eventually, chest compressions that are not frequent enough, not deep enough, or not followed by a full release may fail to maintain the blood circulation required to prevent organ damage and death.

In this regard, it is possible to use a cardiopulmonary resuscitation system to always maintain an optimal standard in the quality of the cardiopulmonary resuscitation performed, minimizing the interruptions of compressions. This system represents a valuable support for operators, allowing them to perform hands-free compressions and to concentrate on other critical therapies while maintaining a greater level of safety even during the transport of the patient, between hospital wards or in an ambulance.

Cardiopulmonary resuscitation systems typically hold the patient in a supine position, i.e. lying on the back, and then repeatedly compress and release the patient's chest. In addition, cardiopulmonary resuscitation systems can be programmed to automatically follow guidelines, compressing and releasing with the recommended rate, reaching a specific depth.

The International Patent Application (PCT) n. WO2016135556 A1 and the International Patent Application (PCT) n. WO2019133948 A1 disclose a cardiopulmonary resuscitation system comprising a support frame, a chest compression device coupled to the support frame and a patient support structure. The support frame and the support structure are assembled together to form a closed loop that surrounds the patient's torso and a piston of the chest compression device is movable in the direction of the patient's chest. In addition, the cardiopulmonary resuscitation system is equipped with a stabilizer element to prevent the support structure from tilting during the activation of chest compressions to the patient.

The purpose of rapid intervention in patient resuscitation implies the need to provide cardiopulmonary resuscitation systems compact enough to be transported to the intervention site, typically defined by a plurality of disassembled and to be assembled components as well as an electronic management system of the resuscitation activities. Cardiopulmonary resuscitation systems of the known type therefore allow optimal management of resuscitation activities but must necessarily be used by qualified and trained personnel. In addition, the electronic management of the systems makes them particularly complex and delicate at the same time, effectively requiring the verification of the presence of an electrical connection or batteries to support operations.

The International Patent Application (PCT) n. WO2008097153 discloses a cardiopulmonary resuscitation system of the pneumatically operated type and comprises a flexible pneumatic actuator, capable of axial contraction when fed with a pressurized drive gas, and means for controlling said contraction.

It would therefore be desirable to have a cardiopulmonary resuscitation system capable of minimizing the aforementioned drawbacks. In this regard, it would be desirable to have a cardiopulmonary resuscitation system capable of being used by operators without specific training and to be used in any condition, while maintaining the optimal resuscitation characteristics. In particular, it would be desirable to have a cardiopulmonary resuscitation system capable of guaranteeing operation on any surface and place, even without power supply.

### BRIEF DESCRIPTION OF THE INVENTION

The object of the present invention is to provide a cardiopulmonary resuscitation system capable of minimizing the aforementioned problems.

In this regard, the object of the present invention is to provide a cardiopulmonary resuscitation system capable of reducing production costs and complexity of use. In particular, the object of the present invention is to provide a pneumatically operated cardiopulmonary resuscitation system capable of guaranteeing cardiopulmonary resuscitation capabilities in any place and by operators without specific training.

The aforementioned purposes are achieved by a cardiopulmonary resuscitation system, in accordance with the attached claims.

The cardiopulmonary resuscitation system comprises:
a chest compression device pneumatically operated;
a support frame of the chest compression device;
coupling means of the chest compression device to a patient;
a pneumatic circuit for actuating the chest compression device;

wherein the support frame is defined by a support plate,

wherein the chest compression device is solidly coupled to the support plate at a side of the support plate, and

wherein the coupling means comprise a pairs of anchoring devices arranged on opposite ends of the support plate and suitable for anchoring the support plate to the ground,

the cardiopulmonary resuscitation system is characterized in that the pairs of anchoring devices consist of belts provided with at least an end operatively coupled respectively to one of the opposite ends of the support plate, and

wherein each of the anchoring devices defines at least a loop allowing an operator to hold them onto the ground by inserting the terminal segment of the upper or lower limbs of operator within the loops.

In this way, it is possible to define cardiopulmonary resuscitation system which is exclusively pneumatically operated, reducing costs and maintenance times and improving the capability of use in any condition.

In an embodiment, each of the anchoring devices comprises a pairs of loops allowing an operator to hold them onto the ground, wherein each pair of loops is spaced in opposite positions on the same opposite end.

In this way, the coupling means allow the cardiopulmonary resuscitation system to be anchored without the need to move the patient and, therefore, speeding up the intervention capability.

In an embodiment, the loops are adjustable to modify the spacing of the support plate from the ground.

In an embodiment, the support plate has a length ranging from 300 mm to 500 mm, preferably equal to 400 mm.

The dimensioning of the support plate is, therefore, such as to ensure the correct support as well as ease of use in use.

In an embodiment, the pneumatic circuit comprises a first portion, able to actuate the chest compression device, and a second portion, able to actuate a lung insufflation device,

wherein the first portion of the pneumatic circuit comprises a first pulse counter and the second portion of the pneumatic circuit comprises a second pulse counter, and

wherein the first pulse counter and the second pulse counter are able to alternatively actuate the first portion and the second portion of the pneumatic circuit.

The pneumatic circuit therefore allows to operate both the chest compression device and the lung insufflation device, synchronizing their use with a single actuation.

In an embodiment, the chest compression device comprises a first fixed sleeve, a second mobile sleeve which is concentric with respect to the first sleeve and a mobile piston which is concentric with respect to the second sleeve,

wherein the chest compression device is mobile following a pneumatic actuation of the pneumatic circuit between a rest position, wherein the second sleeve and the piston are withdraw and housed in the first sleeve, and a working position, wherein the second sleeve is extended of a predetermined first stroke with respect to the first sleeve and the piston is extended of a predetermined second stroke with respect to the second sleeve,

wherein in the working position the summation of the first stroke and of the second stroke is such as to determine the chest compression of the patient.

The realization of the chest compression device using the aforementioned elements allows, therefore, to reduce the size while maintaining the intended use.

In an embodiment, the chest compression device comprises an elastic device with predetermined preload and such as to dispose the chest compression device from the working position to the rest position after the stop of the pneumatic actuation of the pneumatic circuit.

In an alternative embodiment, the chest compression device comprises a bellows piston provided with a deformable chamber defined by an extensible wall,

wherein the chest compression device is mobile following a pneumatic actuation of the pneumatic circuit, between a rest position, wherein the extensible wall is withdraw defining a minimum volume of the deformable chamber, and a working position, wherein the extensible wall is extended defining a maximum volume of the deformable chamber,

wherein in the working position the extension of the deformable chamber is such as to determine the chest compression of the patient.

The realization of the chest compression device by means of a bellows piston therefore allows to reduce the number of components used.

### DESCRIPTION OF THE FIGURES

These and further characteristics and advantages of the present invention will become evident from the description of the preferred embodiments, illustrated by way of non-limiting example in the attached figures, in which:

FIG. 1 is a front perspective view of a first embodiment of the cardiopulmonary resuscitation system, according to the present invention;

FIG. 2 is a front plan view of the cardiopulmonary resuscitation system of FIG. 1;

FIG. 3 is a sectional side plan view of the cardiopulmonary resuscitation system of FIG. 1;

FIG. 4 is a top plan view of the cardiopulmonary resuscitation system of FIG. 1;

FIG. 5 is a front plan view of the cardiopulmonary resuscitation system of FIG. 1, when in use on a patient;

FIG. 6 is a schematic view of the pneumatic circuit of the cardiopulmonary resuscitation system of FIG. 1;

FIG. 7 is a front perspective view of a second embodiment of the cardiopulmonary resuscitation system, according to the present invention;

FIG. 8 is a top plan view of the cardiopulmonary resuscitation system of FIG. 7;

FIG. 9 is a sectional front plan view of the cardiopulmonary resuscitation system of FIG. 7;

FIG. 10 is a front plan view of the cardiopulmonary resuscitation system of FIG. 7, when in use on a patient.

### DETAILED DESCRIPTION OF THE INVENTION

The term “loop” means, in the present invention, a ring in which it is possible to insert the terminal segment of the upper limbs, i.e. a hand, or lower limbs, i.e. a foot.

The term “bellows” means, in the present invention, an element that can be extended by booklet folding, made of flexible material, which constitutes the walls of a deformable chamber.

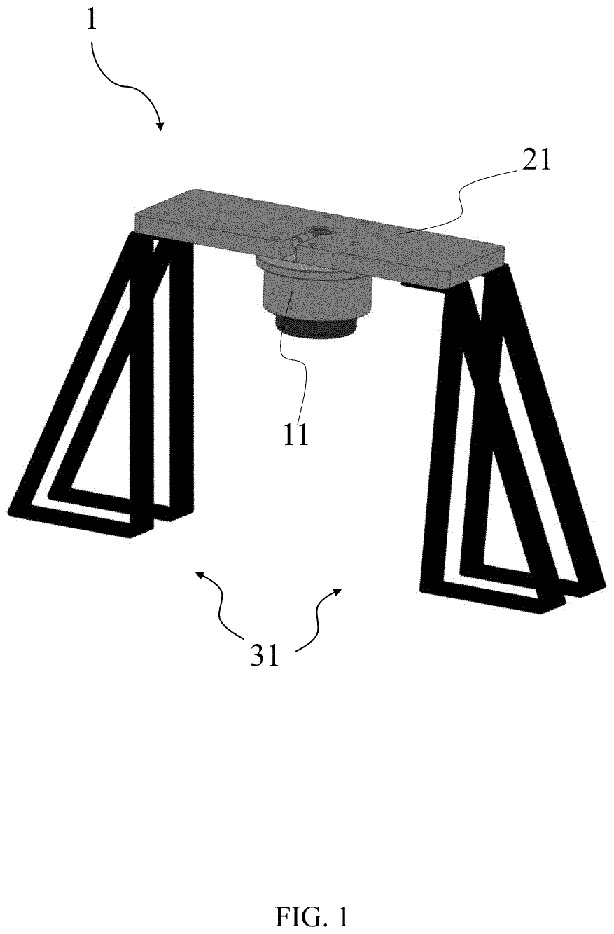

FIGS. 1-6 illustrate a first preferred embodiment of the cardiopulmonary resuscitation system 1 according to the present invention. In particular, FIG. 1 illustrates a front perspective view where it is possible to identify a chest compression device 11 pneumatically operated, a support frame 21 for the chest compression device 11, coupling means 31 of the chest compression device 11 to a patient.

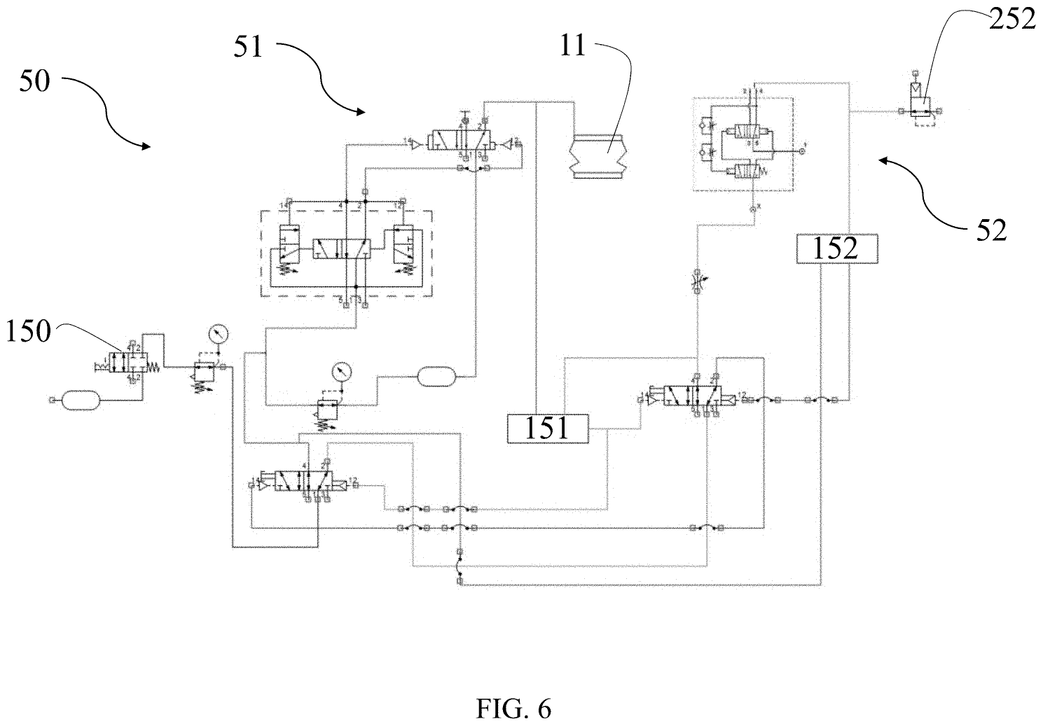

The pneumatic circuit 50 for activating the chest compression device 11 is not shown in FIG. 1 but schematically in FIG. 6, schematically divided into two portions, a first portion 51 suitable for operating the aforementioned chest compression device 11 and a second portion 52 suitable for actuate a lung insufflation device, the latter not shown and operated by means of a pressure regulator 252 disposed at the outlet from said second portion 52 of the pneumatic circuit 50.

The first 51 and second 52 portions of the pneumatic circuit 50 have different components in common but it is possible to identify for each at least one first pulse counter 151, arranged in the first portion 51 of the pneumatic circuit 50, and a second pulse counter 152, arranged in the second portion 52 of circuit 50 pneumatic. The aforementioned first 151 pulse counter and second 152 pulse counter are able to alternately operate the aforementioned first 51 portion and second 52 portion of the pneumatic circuit 50 following the operation of a cycle start tap 150, as detailed below.

The support frame 21 is defined by a support plate 21, preferably made of plastic material in such a way as to define a frame which is sufficiently light and rigid at the same time. This support plate 21 has two opposing major sides 121, 221 separated by the thickness dimension, as well as, for each major side 121, 221, two opposite ends 321, 421 separated by the length dimension and two opposite ends 521, 621 separated by the width dimension. The major sides 121, 221 therefore define the side 121 which in use will be in correspondence with the patient to be resuscitated and the side 221 which in use will be in an opposite position with respect to the patient to be resuscitated.

The dimensions of the support plate 21 are preferably equal to 400 mm for the length, 160 mm for the width and 20 mm for the thickness.

The length dimension of the support plate 21 can be modified within a range preferably of 100 mm, determining a length range comprised between 300 mm and 500 mm. The increase in length allows more stability of the cardiopulmonary resuscitation system 1 during use but affects its handling, therefore the change in length must be evaluated according to the needs and preferably contained within the limits indicated above.

It is also possible to modify the width dimension of the support plate 21 preferably within a range preferably of 40 mm, determining a width range comprised between 120 mm and 200 mm. The dimensions of the width can be modified according to the selection of the appropriate length, where the same considerations for the length also apply to the width, i.e. the increase in width allows more stability of the cardiopulmonary resuscitation system 1 during use but affects handling.

The support plate 21 acts as a frame both for the coupling means 31 and for the chest compression device 11.

The coupling means 31 comprise a pair of anchoring devices 131, 231 arranged on opposite ends of the support plate 21 in particular arranged on the two opposite ends 321, 421 separated by the length dimension, and suitable for anchoring the support plate 21 to the ground. The anchoring devices 131, 231 are made by means of suitable belts preferably made of plastic material, for example textile fibers in synthetic polyamide including aliphatic polyamides, or nylon, or aromatic polyamides, or Kevlar or Nomex. Each belt is provided with the ends, or at least one end, operatively coupled to the support plate 21 in particular to one of the opposite ends 321, 421 of the same support plate 21, preferably at the side 121 which in use will be in correspondence of the patient 200 to be resuscitated, where the chest compression device 11 will be arranged on the same side, as discussed in greater detail below. It is also possible to couple the belts to the support plate 21 at the side 221 which in use will be opposite the patient 200 to be resuscitated, although this is not the preferred technical solution.

In particular, in the first embodiment described therein and illustrated in FIGS. 1-6, each anchoring device 131, 231 defines a pair of loops. Therefore, there are four belts in which each loop is made by winding and fixing each respective belt on itself. The loops are designed to allow an operator to hold them onto the ground 100 by inserting the terminal segment of the upper or lower limbs of the said operator within the said loops. Each pair of loops is spaced in opposite positions on the same end, or on the two opposite ends 521, 621 separated by the width dimension.

The loops are adjustable to modify the distance from the ground 100 of the support plate 21, as illustrated in FIG. 5, and therefore define a ring in which it is possible to insert the terminal segment of the upper limbs, hand, or lower, foot 300, of the operator during the manipulation and use of the cardiopulmonary resuscitation system 1. Even if not illustrated, each of the four belts is equipped with a buckle which allows the closure of the same and the adjustment of the height of the support plate 21 with respect to the ground 100, as a consequence of the widening or narrowing of the size of the defined loop. The spacing from the ground 100 is made according to the chest size of the patient 200, after the insertion of the feet 300 of the operator for anchoring the support plate 21 to the ground 100, and as consequence for anchoring the entire cardiopulmonary resuscitation system 1.

According to further embodiments, not illustrated, it is also possible to provide for each of the anchoring devices a single loop, or a single belt, for each of the opposite ends and suitable for allowing an operator to restrain the ground by inserting of the terminal segment of the upper or lower limbs of the said operator within the said loops.

Likewise, it is possible to use materials other than the plastic ones above identified.

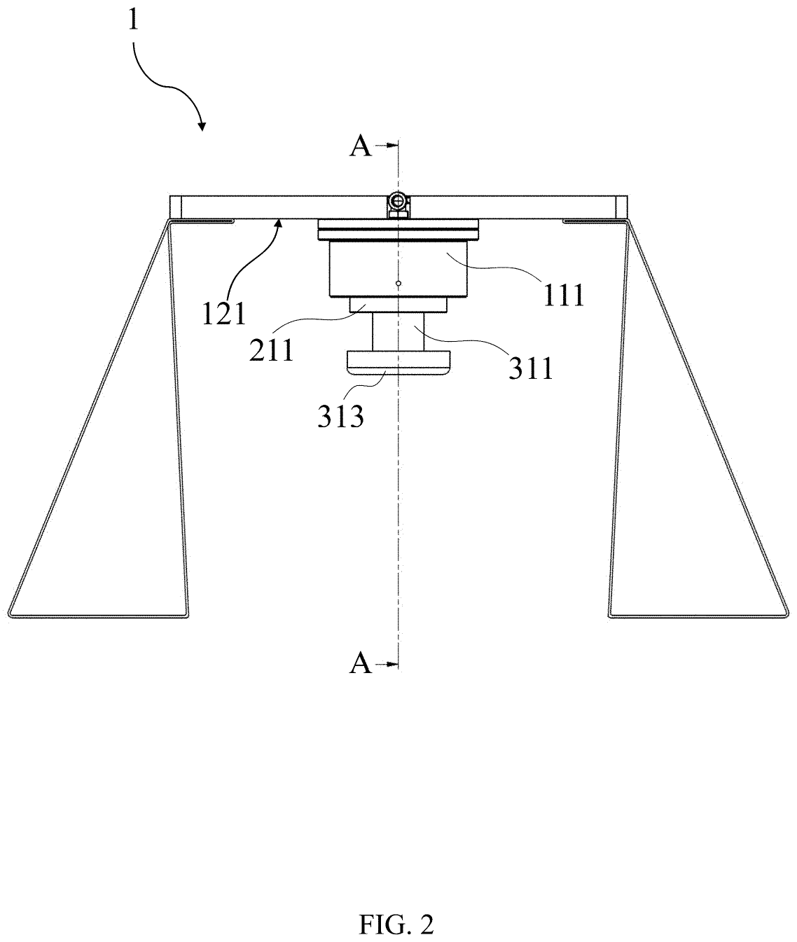

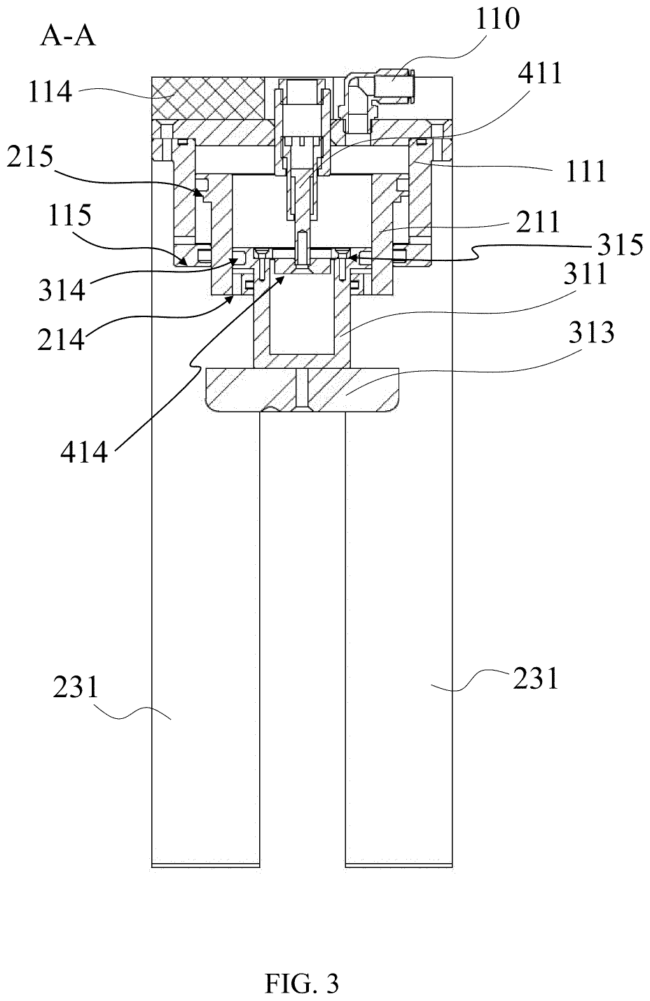

Finally, the cardiopulmonary resuscitation system 1 according to the first embodiment of the present invention comprises a chest compression device 11 integrally coupled to the support plate 21 at one side of the plate 21 itself, i.e. at the side 121 which in use will be in correspondence with the patient to be resuscitated, as well illustrated in the attached Figures and, in particular, in the section of FIG. 3, defined with respect to the section line AA of FIG. 2.

The chest compression device 11 is configured to be mobile, at least in some components, between a rest position and a working position, in which the aforementioned working position corresponds to the application of chest compression to the patient, vice versa the rest position corresponds to the non-application of the same chest compression.

In the first embodiment illustrated therein, the chest compression device 11 comprises three main elements, namely a first jacket 111, a second jacket 211 and a piston 311. The aforesaid elements are preferably made of aluminum alloy and have dimensions such as to allow the relative concentric housing, i.e. the first sleeve 111 is capable of housing the second sleeve 211 which, at the same time, is capable of housing the piston 311 (where the piston in the embodiment described therein is only partially housed within the second sleeve). Furthermore, the second sleeve 211 is concentric with respect to the first sleeve 111 and the piston 311 is concentric with the second sleeve 211 and, consequently, with the first sleeve 111. Furthermore, the coupling of the aforementioned elements defines an internal chamber with variable volume, wherein the minimum volume is defined in the rest position and the maximum volume is defined in the working position. Therefore, the overall length of the chest compression device 11, when in the rest position, is preferably equal to 93 mm with a diameter preferably equal to 118 mm.

A pad 313 is fixed to the base of the piston 311, that is to the outermost portion of the chest compression device 11 in correspondence with the patient 200, which represents the component in contact with the patient's chest during the rest position, i.e. the component capable of to apply chest compression in the working position. The pad 313 is preferably made of plastic material, for example rubber, and has a diameter preferably equal to 90 mm and a thickness preferably equal to 20 mm.

The chest compression device 11 is therefore movable between a rest position, in which the second sleeve 211 and the piston 311 are retracted and housed in the first sleeve 111 as illustrated in FIGS. 1 and 5, and a working position (not illustrated), in which the second sleeve 211 is extended with respect to the first sleeve 111 by a first predetermined stroke and the piston 311 is extended with respect to the second sleeve 211 by a second predetermined stroke, following pneumatic actuation from the pneumatic circuit 50.

FIGS. 2 and 3 show an intermediate position between the rest position and the working position, in which the piston 311 is extended with respect to the second sleeve 211 but the same second sleeve 211 is still housed within the first sleeve 111.

As previously described, the working position corresponds to the position in which the chest compression is applied to the patient 200, therefore in the aforementioned working position the sum of the first stroke and the second stroke is such as to determine the chest compression of the patient 200.

The first sleeve 111 therefore defines the structural support and the container of the further movable elements, relating to the second sleeve 211 and to the piston 311, and is closed in an opposite position to the pad 313 by a closing flange 114, preferably made of metal. The movement of the piston 311 is guided by a guide shaft 411, arranged concentrically with respect to all the aforesaid elements and provided in its terminal portion with a guide flange 414 to maintain the movement of the piston 311 in a linear direction. Similarly, the piston 311 is provided with a portion 315 for coupling with the aforementioned guide flange 414 as well as with a driving flange 314 for the second sleeve 211, arranged in the end portion opposite to the head, which allows the second sleeve 211 to be moved following the movement of the piston 311. Therefore, the second sleeve 211 is provided with a portion 215 for coupling with the aforementioned driving flange 314 as well as a stop flange 214 with respect to the first sleeve 111, arranged in the opposite end portion with respect to the said coupling portion 215. Finally, the first sleeve 111 is provided with a stop flange 115 arranged in the opposite end portion with respect to the closing flange 114.

The compressed air for moving the piston 311, as well as the second sleeve 211, is introduced into the chest compression device 11 by means of a threaded fitting 110 which protrudes from the closing flange 114, and is adapted to connect the pneumatic circuit 50 with the internal chamber with variable volume.

According to further embodiments, not shown, it is also possible that the chest compression device comprises an elastic device with predetermined preload and such as to arrange the chest compression device from the working position to the rest position following interruption of the pneumatic actuation from the pneumatic circuit. This elastic device therefore defines a double-acting implementation as opposed to the single-acting implementation defined in the first embodiment described above.

The use of cardiopulmonary resuscitation system 1 is detailed below with respect to application on a patient 200 following a cardiac arrest of the same. It is assumed that the patient 200 is disposed, or has been positioned, supine on a ground 100 which defines his support plane.

The cardiopulmonary resuscitation system 1 is, therefore, laid over the patient's chest 200 by arranging the support plate 21 with the side 121, provided with the chest compression device 11, in correspondence with the patient 200 to be resuscitated. In this way, the pad 313 will be the only element in direct contact with the patient's chest 200 and will insist with a force equal to the weight of the cardiopulmonary resuscitation system 1 alone.

To allow anchoring of the cardiopulmonary resuscitation system 1 to the ground 100, the operator must adjust the coupling means 31 according to the size of the patient 200. This adjustment can take place, for example, by means of the appropriate buckles with which the anchoring devices 131, 231, so that the latter can make loops of adequate size for the insertion of the feet 300 of the operator and of sufficient length to reach the ground 100 while maintaining normal contact of the pad 313 on the patient's chest.

The cardiopulmonary resuscitation system 1 has the pneumatic circuit 50, used to supply both the chest compression device 11, then the application of compressed air for the expansion of the internal chamber with variable volume which allows the movement of the piston 311 and the further elements that determine the chest compression, is the lung insufflation device (not shown) for carrying out the air insufflations to the patient 200 as per the resuscitation protocol. The aforementioned pneumatic circuit 50 therefore allows coupling with the necessary pneumatic supply, for example a cylinder of compressed air suitable for carrying out the required activities and preferably of the portable type in order to be handled together with the cardiopulmonary resuscitation system 1.

The cardiopulmonary resuscitation system 1 will be activated by means of the cycle start tap 150 which arranges the passage of compressed air from the cylinder to the pneumatic circuit 50 and, consequently, to their elements, including the aforementioned first 151 and second 152 pulse counters. These are able to actuate the aforesaid first 51 portion and second 52 portion of the pneumatic circuit 50 alternatively. In particular, the first portion 51 of the pneumatic circuit 50 used for feeding the chest compression device 11 is closed to the passage of air when the second portion 52 of the pneumatic circuit is fed through which the insufflations are carried out. In the same way, the second portion 52 of the pneumatic circuit 50 is closed to the passage of air when the aforementioned first portion 51 is supplied. The activation of the first 51 or of the second 52 portion of the circuit is managed by the two pulse counters 151, 152, according to the protocol to be performed, that is, after having identified the number of pulses such as to define the closure of the supply valves of one of the two portions of the pneumatic circuit 50.

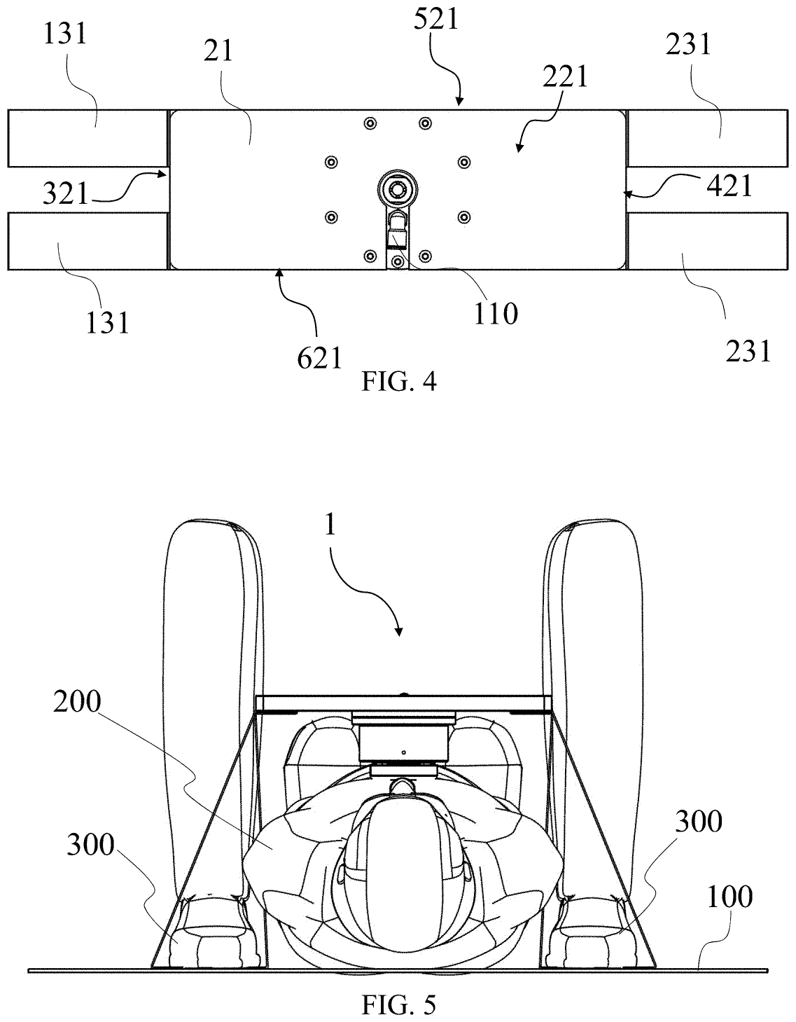

As regards the first portion 51 of the pneumatic circuit 50, the compressed air entering the threaded fitting 110 protruding from the closing flange 114, as illustrated for example in FIGS. 3 and 4, enters the variable volume internal chamber of the chest compression device 11. The compressed air insisting on the head of the piston 311 allows it to be moved downwards, or in the direction of the patient's chest 200, carrying out the required chest compressions. During the aforementioned movement, the coupling portion 315 of the piston 311 meets the guide flange 414 located downstream of the guide shaft 411 which maintains the linear movement of the device 11 and allows to define the stroke end position of the piston 311. Upon completion of the extension of the piston 311, or the second stroke, the movement of the second sleeve 211 is actuated with respect to the first sleeve 111. In this regard, the piston 311 is provided with a driving flange 314 which contacts the stop flange 214 of the second sleeve 211, where the coupling between the driving flange 314 and the stop flange 214 allows the excursion of the second sleeve 211 or the realization of the first stroke. Finally, the limit switch is determined by the coupling between the coupling portion 215 of the second sleeve 211 with the stop flange 115 of the first sleeve 111. At the end of the aforementioned excursions, the sum of the first and second strokes corresponds to the position of work to determine the patient's chest compression 200.

At the end of the chest compression, the temporary interruption of the supply of compressed air to the chest compression device 11 determines the interruption of the working position, i.e. the return to the rest position, possibly with the help of an elastic device with preload predetermined.

The supply of compressed air to the chest compression device 11 takes place, therefore, for a determined number of pulses counted from the first pulse counter 151 up to the maximum predetermined number that defines the suspension of the chest compression cycle and the initiation of the insufflation cycle.

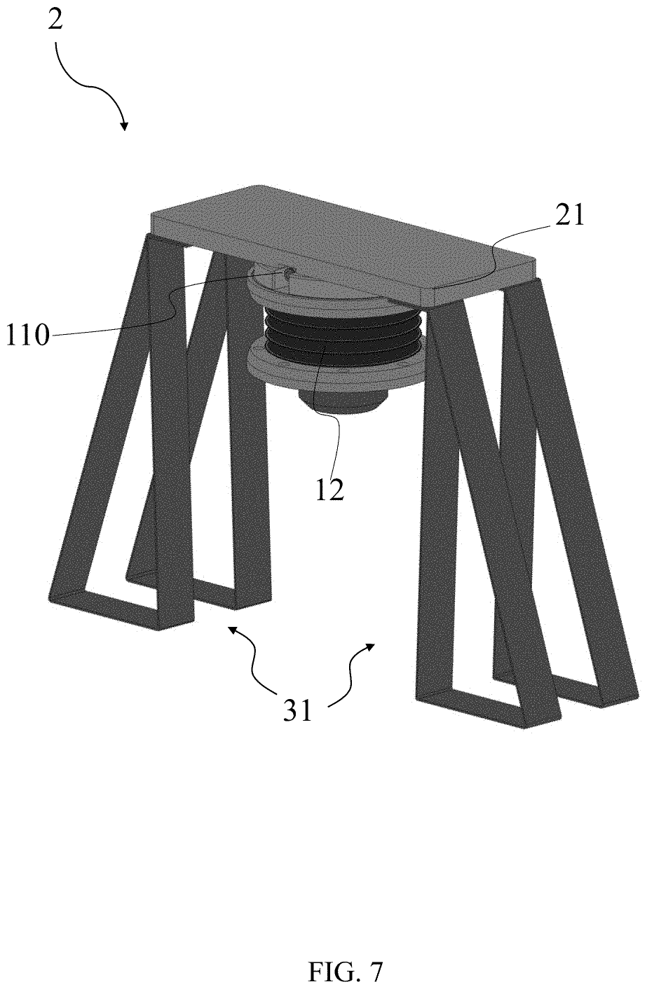

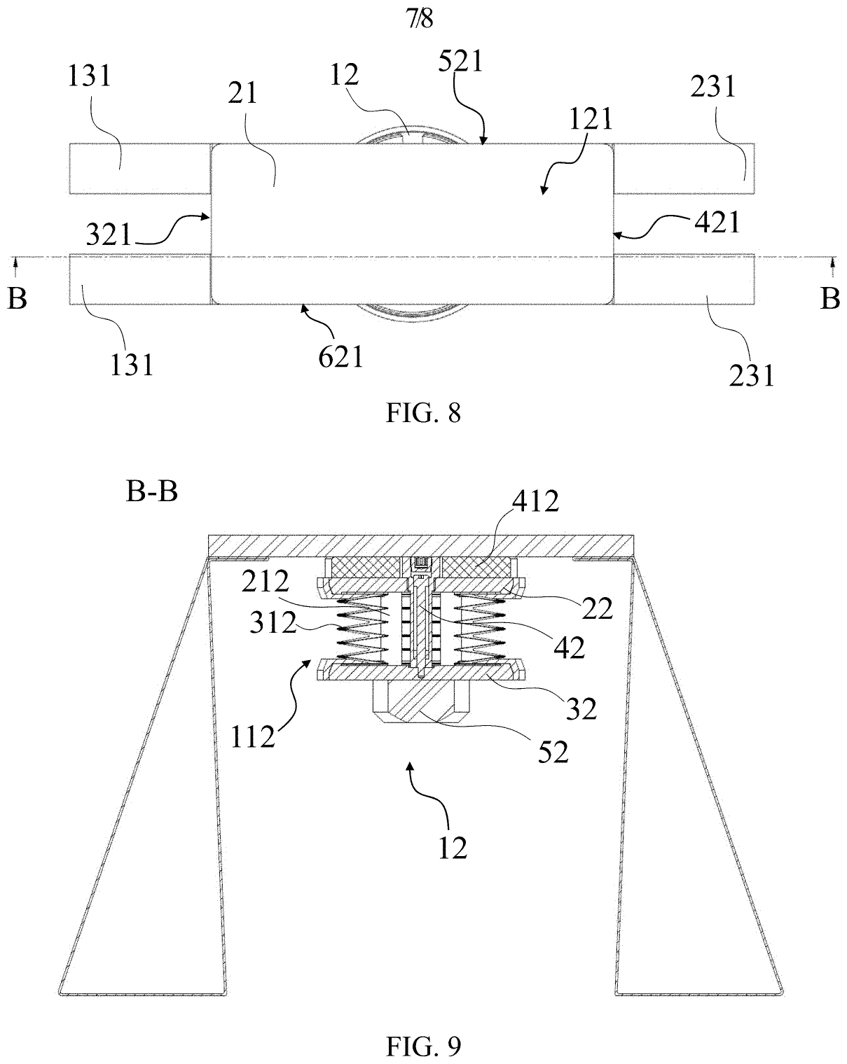

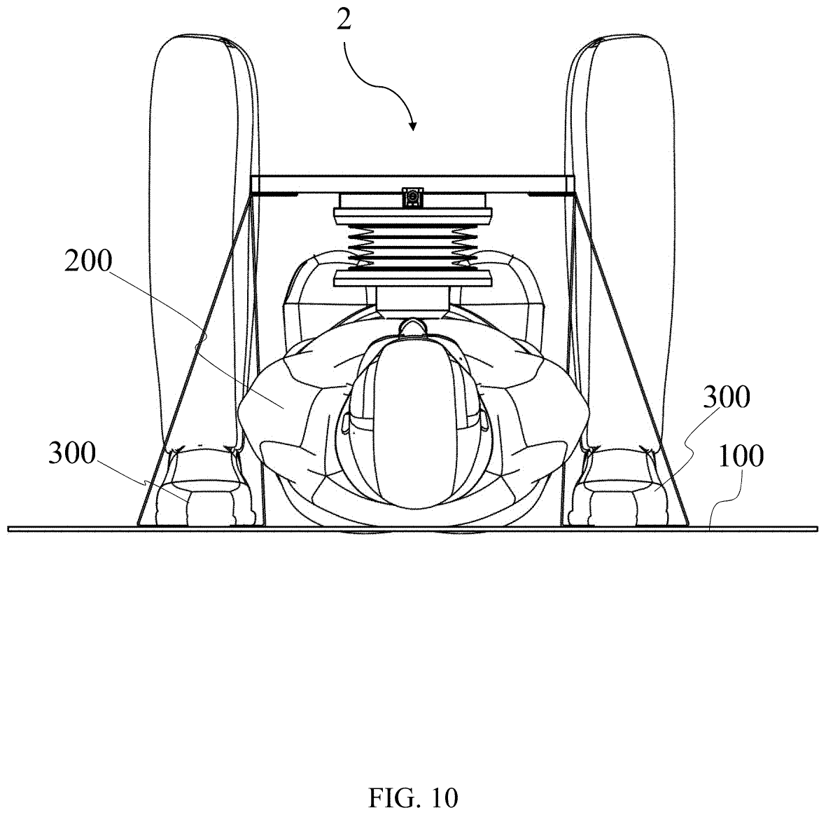

A second embodiment of the cardiopulmonary resuscitation system 2 according to the present invention is illustrated in FIGS. 7-10 and described below, where the use of the same components described in the cardiopulmonary resuscitation system 1 will be defined maintaining the same numbering of the aforementioned first embodiment. For this purpose, the system 2 of the second embodiment will be described in detail only in the components which differ with respect to the system 1 of the first embodiment as illustrated in FIG. 7, i.e. with respect to the chest compression device 12.

In this second embodiment, the cardiopulmonary resuscitation system 2 comprises a chest compression device 12 different from the same chest compression device 11 previously described. In particular, the chest compression device 12 comprises a bellows piston 112 provided with a deformable chamber 212 defined by an extensible wall 312, as illustrated in greater detail in the section of FIG. 9.

The deformable chamber 212 also has a pair of plates which define the sides of the relative ends, that is an end plate 32, at the patient's chest 200, and a closing plate 22 opposite the aforementioned end plate 32. A guide shaft 42 is arranged within the deformable chamber 212 and is provided with a fixed portion coupled to the closure plate 22 and a movable portion coupled to the end plate 32. The aforementioned portions allow the extension of the extendable wall 312 while maintaining a guide by means of the aforementioned guide shaft 42, with the same function described above for the guide shaft 411 of the first embodiment.

The thoracic compression device 12 is therefore movable between the rest position (as previously described), in which the extensible wall 312 is retracted defining the minimum volume of the said deformable chamber 212, and a working position (as previously described), in which the extensible wall 312 is extended defining the maximum volume of the deformable chamber 212, following pneumatic actuation from the pneumatic circuit 50. Therefore, as described above, in the working position the extension of the deformable chamber 212 is such as to determine the chest compression of the patient 200.

The operation of the cardiopulmonary resuscitation system 2, or of the relative chest compression device 12, will not be further described since it substantially corresponds to the description previously made for the system 1 according to the first embodiment.

The advantages of the cardiopulmonary resuscitation system according to the present invention compared to traditional systems are, therefore, high compactness and reduced dimensions corresponding to a reduced weight, with high ease of use even by a single operator.

The cardiopulmonary resuscitation system according to the present invention is, moreover, exclusively pneumatic actuated without the need for mechanical adjustments, therefore devoid of any need for assembly or adjustment. In particular, the totally pneumatic actuation for both chest compressions and patient ventilations, through a single pneumatic circuit and without any electrical or electronic systems, allows to minimize management and maintenance costs, avoiding the limits deriving from the duration (or useful life) of any batteries, or the need to proceed with programmed maintenance to ensure their functionality at any time even in the absence of use.

Furthermore, the use of the cardiopulmonary resuscitation system according to the present invention is particularly suitable in hostile environments, such as on snow or in extreme cold conditions, where the durability performance of known devices can be negatively affected by adverse climatic factors.

A further distinctive element are the coupling means that allow the use of the cardiopulmonary resuscitation system without moving the patient from the supine position and without any need to place further elements under it to ensure coupling.

Finally, the cardiopulmonary resuscitation system according to the present invention allows use by operators not specifically trained, or by non-medical staff as well.

1. Cardiopulmonary resuscitation system (1; 2) comprising:
a chest compression device (11; 12) pneumatically operated;
a support frame (21) of said chest compression device (11; 12);
coupling means (31) of said chest compression device (11; 12) to a patient (200);
a pneumatic circuit (50) for actuating said chest compression device (11; 12);
wherein said support frame is defined by a support plate (21),
wherein said chest compression device (11; 12) is solidly coupled to said support plate (21) at a side (121) of said support plate (21),
wherein said coupling means (31) comprise a pairs of anchoring devices (131, 231) arranged on opposite ends (321, 421) of said support plate (21) and suitable for anchoring said support plate (21) to the ground (100),
wherein said pairs of anchoring devices (131, 231) consist of belts provided with at least an end operatively coupled respectively to one of said opposite ends (321, 421) of said support plate (21), and
wherein each of said anchoring devices (131, 231) defines at least a loop allowing an operator to hold them onto the ground (100) by inserting the terminal segment of the upper or lower limbs of said operator within said loops.

2. Cardiopulmonary resuscitation system (1; 2) according to claim 1, wherein each of said anchoring devices (131, 231) comprises a pairs of loops allowing an operator to hold them onto the ground (100), wherein each pair of loops is spaced in opposite positions on the same opposite end (521, 621).

3. Cardiopulmonary resuscitation system (1; 2) according to claim 1, wherein said loops are adjustable to modify the spacing of said support plate (21) from said ground (100).

4. Cardiopulmonary resuscitation system (1; 2) according to claim 1, wherein said support plate (21) has a length ranging from 300 mm to 500 mm, preferably equal to 400 mm.

5. Cardiopulmonary resuscitation system (1; 2) according to claim 1, wherein said pneumatic circuit (50) comprises a first portion (51), able to actuate said chest compression device (11; 12), and a second portion (52), able to actuate a lung insufflation device, wherein said first portion (51) of said pneumatic circuit (50) comprises a first pulse counter (151) and said second portion (52) of said pneumatic circuit (50) comprises a second pulse counter (152), and wherein said first pulse counter (151) and said second pulse counter (152) are able to alternatively actuate said first portion (51) and said second portion (52) of said pneumatic circuit (50).

6. Cardiopulmonary resuscitation system (1) according to claim 1, wherein said chest compression device (11) comprises a first fixed sleeve (111), a second mobile sleeve (211) which is concentric with respect to said first sleeve (111) and a mobile piston (311) which is concentric with respect to said second sleeve (211), wherein said chest compression device (11) is mobile following a pneumatic actuation of said pneumatic circuit (50) between a rest position, wherein said second sleeve (211) and said piston (311) are withdraw and housed in said first sleeve (111), and a working position, wherein said second sleeve (211) is extended of a predetermined first stroke with respect to said first sleeve (111) and said piston (311) is extended of a predetermined second stroke with respect to said second sleeve (211), and wherein in said working position the summation of said first stroke and of said second stroke is such as to determine the chest compression of said patient (200).

7. Cardiopulmonary resuscitation system (1) according to claim 6, wherein said chest compression device (11) comprises an elastic device with predetermined preload and such as to dispose said chest compression device (11) from said working position to said rest position after the stop of the pneumatic actuation of said pneumatic circuit (50).

8. Cardiopulmonary resuscitation system (2) according to claim 1, wherein said chest compression device (12) comprises a bellows piston (112) provided with a deformable chamber (212) defined by an extensible wall (312), wherein said chest compression device (12) is mobile following a pneumatic actuation of said pneumatic circuit (50), between a rest position, wherein said extensible wall (312) is withdraw defining a minimum volume of said deformable chamber (212), and a working position, wherein said extensible wall (312) is extended defining a maximum volume of said deformable chamber (212), and wherein in said working position the extension of said deformable chamber (212) is such as to determine the chest compression of said patient (200).
